(19) United States
(12) Patent Application Publication
(10) Pub. No.: US 2024/0053223 A1
(43) Pub. Date: Feb. 15, 2024

(54) ELECTRONIC TOILET WATER CONTROL VALVE

(71) Applicant: Mark Bushrod, Cochrane (CA)

(72) Inventor: Mark Bushrod, Cochrane (CA)

(21) Appl. No.: 17/884,721

(22) Filed: Aug. 10, 2022

(51) Int. Cl. G01M 3/28; G05D 7/06; G08B 21/18

(52) U.S. Cl. CPC G01M 3/2815; G05D 7/0635; G08B 21/18; E03D 11/00

(57) ABSTRACT

An electronic toilet water control system includes a valve, an actuator, at least one sensor and a controller. The electronic toilet water control system connects directly to a water supply line supplying water to a toilet and the at least one sensor senses a flow and/or a pressure of water in the water supply line. As such, the electronic toilet water control system is able to sense potential leaks or free running water and controls the water supply to the toilet accordingly. Thus, the toilet water control system is used to prevent floods, damage, water waste, and high costs associated therewith.

### CROSS-REFERENCE TO RELATED APPLICATION

The present application is related to and claims priority to U.S. Provisional Patent Application No. 63/223,129 filed Jul. 19, 2021, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of water valves of existing art and more specifically relates to an electronic valve for controlling toilet water supply in the event of an abnormal condition.

### RELATED ART

It is well known that water leaks can cause a plethora of issues. For example, water can cause a tremendous amount of damage to a building and its contents. This can cause substantial financial consequences not only from the cost of actually fixing the damage, but also from the water costs and the rise of insurance premiums. Further, with the ever growing need to conserve water, a water leak is also an environmental concern.

Undetected leaks, particularly from toilets, are one of the most insidious sources of wasted water. Toilet leaks are often an easy fix, however, often times, the signs of a leaky toilet only become evident once the leak has gotten bad and water has already been wasted and/or damage has already been caused. Other times, even if the leak is sudden and easily visible, unless an occupant is within eyesight of the leak, it is generally destructive enough to have already caused a considerable amount of damage before the leak is discovered or the source of the leak is fixed. This is furthered if the occupant is not present when the leak starts. Thus, a suitable solution is desired.

### SUMMARY OF THE INVENTION

In view of the foregoing disadvantages inherent in the known water valve art, the present disclosure provides a novel electronic toilet water control system. The general purpose of the present disclosure, which will be described subsequently in greater detail, is to provide a system that attaches directly to a water supply line of a toilet and prevents unnoticed leaks and other failures which can lead to floods and related damage, wastage, high costs associated therewith and higher insurance premiums.

An electronic toilet water control system is disclosed herein. The electronic toilet water control system may be configured for connection to a water supply line of a toilet. The electronic toilet water control system includes a valve, an actuator, at least one sensor and a controller. The valve may include a valve housing, an inlet and an outlet and the valve may be configured for connection to the water supply line. The actuator may be disposed within the valve housing and configured to selectively move the valve between an open position and a closed position; the open position allowing the water to flow through the valve and into the toilet and the closed position preventing the water from flowing through the valve and into the toilet.

The at least one sensor may be disposed within the valve housing and configured to sense an abnormality in flow and/or pressure of the water and, upon detection of the abnormality, output a signal. The controller may be in communication with the actuator and the at least one sensor. The controller may be configured to receive the signal from the at least one sensor and, upon receipt of the signal, cause the actuator to move the valve into the closed position.

According to another embodiment, a method of controlling water supply to a toilet is also disclosed herein. The method includes providing the electronic toilet water control system as above; sensing, via the at least one sensor, the abnormality in the at least one of the flow and pressure of the water flowing through the valve that has persisted for a predetermined amount of time; outputting, via the at least one sensor, a signal; receiving, via the controller, the signal; and causing, via the controller, the actuator to move the valve into the closed position.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an electronic toilet water control system, constructed and operative according to the teachings of the present disclosure.

FIG. 1 is a perspective view of the electronic toilet water control system attached to a water supply line of a toilet, according to an embodiment of the disclosure.

FIG. 2 is a close-up view of the electronic toilet water control system of FIG. 1, according to an embodiment of the present disclosure.

FIG. 3 is a schematic diagram of the electronic toilet water control system of FIG. 1, according to an embodiment of the present disclosure.

FIG. 4 is a schematic diagram of the electronic toilet water control system of FIG. 1, according to another embodiment of the present disclosure.

FIG. 5 is a flow diagram illustrating a method of controlling water supply to a toilet, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to toilet valves and more particularly to an electronic toilet water control system. Generally, the electronic toilet water control system includes an electronically controlled water valve that is placed on a water supply line of a toilet. The valve may sense a failure condition in the toilet such as the toilet running intermittently (indicating a leak), or freely (indicating possible flood) and in response, shuts off water supply to the toilet and indicates a failure state. Thus, the electronic toilet water control system is used to prevent floods, damage, water waste, and high costs associated therewith.

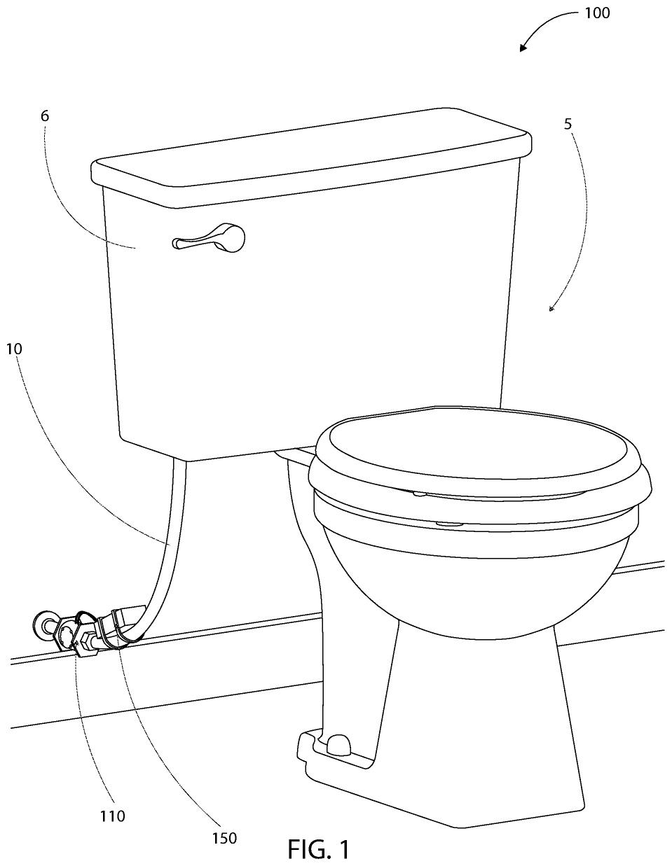

Referring now more specifically to the drawings by numerals of reference, there is shown in FIGS. 1-4, various views of an electronic toilet water control system 100. As shown, the electronic toilet water control system 100 may include a valve 110, an actuator 120, at least one sensor 130 and a controller 140. As shown particularly in FIG. 1, the electronic toilet water control system 100 may be configured for connection to a water supply line 10 of a toilet 5. More specifically, the valve 110 may connect to the water supply line 10 (which supplies the toilet 5 with water). As such, the electronic toilet water control system 100 may be able to ‘monitor’ (discussed in more detail below) water passing through the valve 110, and thus the water supply line 10, and shut off the water supply line 10 (and thus water to the toilet 10) when a leak, malfunction or other failure is detected.

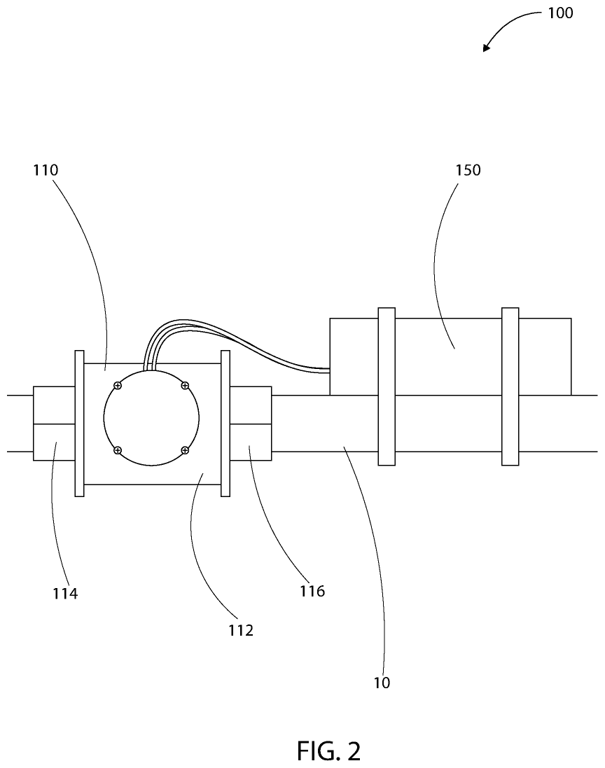

As shown in FIG. 2, the valve 110 may include a valve housing 112, an inlet 114 and an outlet 116. In some embodiments, as shown, the water supply line 10 may include two separate conduits, one connected directly to a water supply of a building and to the inlet 114 of the valve 110; and another connected to the outlet 116 of the valve 110 and directly to a tank 6 of the toilet 5.

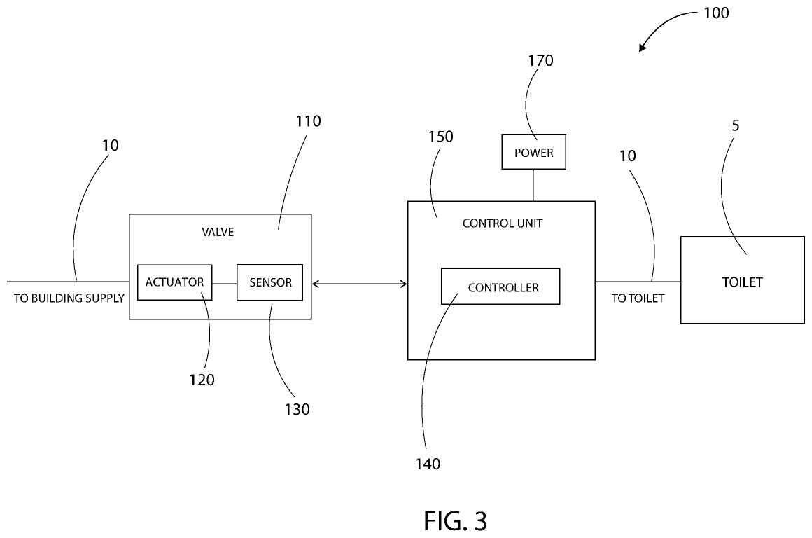

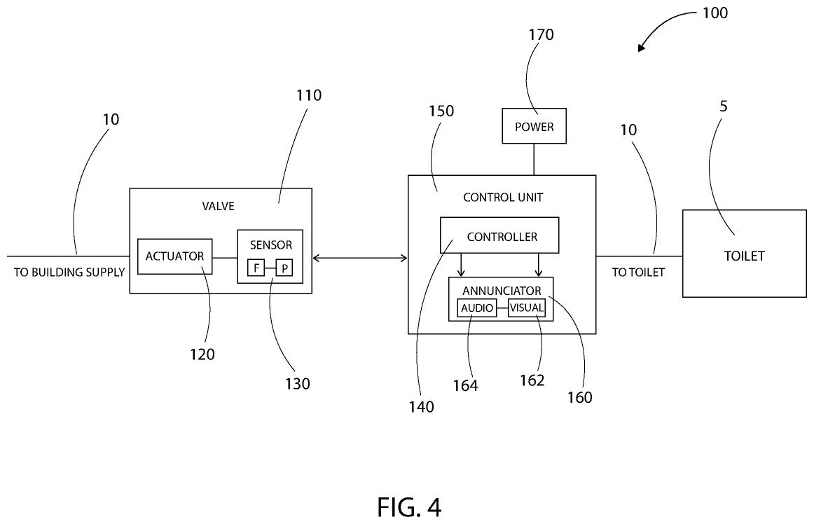

As shown in FIGS. 3-4, the actuator 120 may be disposed within the valve housing 112. The actuator 120 may be configured to selectively move the valve 110 between an open position and a closed position. Naturally, the open position allows the water to flow through the valve 110 and into the toilet 5 (tank 6); and the closed position prevents the water from flowing through the valve 110 and into the toilet 5 (tank 6). In some examples, the actuator 120 may include (but is not limited to) a motor, a solenoid, etc. The valve 110 may include a movable member connected to (or otherwise in communication with the actuator 120) that is moved to close or open the valve 110. Valves contemplated for use may include (but are in no way limited to) a butterfly valve, a plug valve, gate valve, or the like.

In some embodiments, as shown in FIGS. 3-4, the at least one sensor 130 may also be disposed within the valve housing 112. The at least one sensor 130 may be configured to sense an abnormality in a flow and/or a pressure of the water and, upon detection of the abnormality, output a signal (the abnormality being indicative of a leak, flood or other malfunction/failure in the toilet). In some embodiments, the at least one sensor 130 may detect the abnormality based on a predetermined condition being met. For example, low pressure and/or high flow may indicate a stuck valve or a leaking toilet 5. In another example, if the pressure does not stay high (has low pressure) or has no little to no flow, this may indicate an intermittent leak. In contrast, fluctuations in the pressure and the flow of the water may indicate usage and that the toilet 5 is functioning properly.

To add to this and to prevent inadvertent shut off or an overly sensitive sensor 130, the at least one sensor 130 may be configured to sense that the abnormality has persisted for a predetermined amount of time prior to concluding that there is an abnormality and outputting the signal. For example, the at least one sensor 130 may be configured to sense low pressure and/or high flow of the water for at least five consecutive minutes (and again this may indicate the stuck valve or the leaking toilet 5). In another example, the at least one sensor 130 may be configured to sense the low pressure and or little to no flow (‘a no flow condition’) for at least three consecutive hours in a 24 hour time period (which again may indicate the intermittent leak).

One or more sensors may be used in the present disclosure. For example, in some embodiments, one sensor 130 may be used to detect both the pressure and the flow of the water. In another example, as demonstrated in FIG. 4, two sensors may be provided; one to detect pressure and one to detect flow. Examples of sensors contemplated in the present disclosure may include (but are in no way limited to) a water pressure sensor, a flow meter, or the like.

The controller 140 may be in communication with the actuator 120 and the at least one sensor 130. As shown in FIGS. 1-4, in some embodiments, the electronic toilet water control system 100 may further comprise a control unit housing 150. In this embodiment, the controller 140 may be located within the control unit housing 150. The control unit housing 150 may be configured to electrically connect to the valve 110. For example, as show in FIG. 2, this may be (but is not limited to) a wired connection.

The control unit housing 150 may further be configured to attach along the water supply line 10. For example, the control unit housing 150 may include clips, straps or other fasteners to attach the control unit housing 150 to the water supply line 10. In other embodiments, the control unit housing 150 may attach to the valve 110. In other embodiments still, the control unit housing 150 and the valve 110 may be one; and as such, the controller 140 may be located within the valve housing 112. Further, in some embodiments, a power source 170 may be connected to the valve 110 and the control unit housing 150. For example, the power source 170 may include a battery.

The controller 140 may be configured to receive the signal from the at least one sensor 130 and, upon receipt of the signal, cause the actuator 120 to move the valve 110 into the closed position (by sending a signal to the actuator 120). Further, in some embodiments, the electronic toilet water control system 100 may include an annunciator 160, which, in some embodiments may be integral to the control unit housing 150. As such, the controller 140 may be in communication with the annunciator 160 and may be configured to, upon receipt of the signal, cause the annunciator 160 to output an alert to warn a user as to the abnormality (again via signals).

For example, as demonstrated in FIG. 4, the annunciator 160 may preferably include an illuminator 162, such as, but not limited to, a light emitting diode (LED). As such, the alert may be a light, whether it be a colored light or a white light. Thereby, once a leak or other failure has been detected and the valve 110 has been placed into the closed position, the illuminator 162 may emit the light to visually alert the user as to the failure. In another example, in combination with the illuminator 162 or instead of the illuminator 162, the annunciator 160 may also include a loudspeaker 164. As such, the alert may be a sound. Thereby, once the failure has been detected and the valve 110 has been placed into the closed position, the loudspeaker 164 may output the sound to audibly alert the user as to the failure. The sound may be an alarm, a beep, a chime, a voice message, or the like.

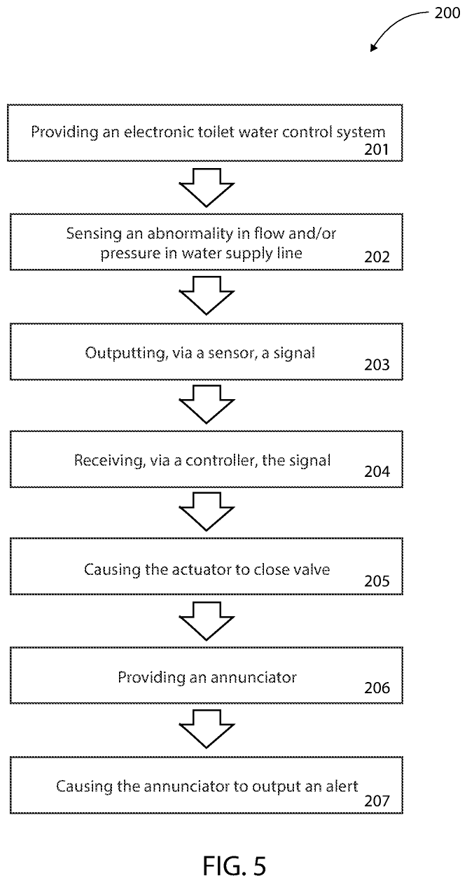

Referring now to FIG. 5 showing a flow diagram illustrating a method of controlling water supply to a toilet 200, according to an embodiment of the present disclosure. In particular, the method 200 may include one or more components or features of the electronic toilet water control system 100 as described above. As illustrated, the method 200 may include the steps of: step one 201, providing the electronic toilet water control system as above; step two 202, sensing, via the at least one sensor, the abnormality in at least one of the flow and pressure of the water flowing through the valve that has persisted for a predetermined amount of time; step three 203, outputting, via the at least one sensor, a signal; step four 204, receiving, via the controller, the signal; and step five 205, causing, via the controller, the actuator to move the valve into the closed position. Further steps may include step six 206, providing the electronic toilet water control further including an annunciator; and step seven 207, causing, via the controller, the annunciator to output an alert to warn a user as to the abnormality. In addition, as discussed above, the step 202 of sensing may include sensing, via the at least one sensor, at least one of low pressure and high flow of the water for at least five consecutive minutes; and sensing, via the at least one sensor, at least one of the low pressure and no flow of the water for at least three consecutive hours in a 24 hour time period.

It should be noted that step certain steps are optional steps and may not be implemented in all cases. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for controlling water supply to a toilet are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An electronic toilet water control system for connection to a water supply line of a toilet, the electronic toilet water control system comprising:
a valve including a valve housing, an inlet and an outlet, the valve being configured for connection to the water supply line;
an actuator disposed within the valve housing and configured to selectively move the valve between an open position and a closed position, the open position allowing the water to flow through the valve and into the toilet, the closed position preventing the water from flowing through the valve and into the toilet;
at least one sensor disposed within the valve housing and configured to sense an abnormality in at least one of a flow and a pressure of the water and, upon detection of the abnormality, output a signal; and
a controller in communication with the actuator and the at least one sensor, the controller configured to receive the signal from the at least one sensor and, upon receipt of the signal, cause the actuator to move the valve into the closed position.

2. The electronic toilet water control system of claim 1, further comprising a control unit housing electrically connectable to the valve, and wherein the controller is located within the control unit housing.

3. The electronic toilet water control system of claim 2, wherein the control unit housing is configured to attach along the water supply line.

4. The electronic toilet water control system of claim 3, further comprising an annunciator, and wherein the controller is further configured to, upon receipt of the signal, cause the annunciator to output an alert to warn a user as to the abnormality.

5. The electronic toilet water control system of claim 4, wherein the annunciator includes an illuminator and wherein the alert is a light.

6. The electronic toilet water control system of claim 5, wherein the alert is a colored light.

7. The electronic toilet water control system of claim 4, wherein the annunciator includes a loudspeaker and wherein the alert is a sound.

8. The electronic toilet water control system of claim 7, wherein the at least one sensor is configured to sense that the abnormality has persisted for a predetermined amount of time.

9. The electronic toilet water control system of claim 8, wherein the at least one sensor is configured to sense at least one of low pressure and high flow of the water for at least five consecutive minutes.

10. The electronic toilet water control system of claim 9, wherein the at least one sensor is configured to sense at least one of the low pressure and no flow of the water for at least three consecutive hours in a 24 hour time period.

11. An electronic toilet water control system for connection to a water supply line of a toilet, the electronic toilet water control system comprising:
a valve including a valve housing, an inlet and an outlet, the valve being configured for connection to the water supply line;
an actuator disposed within the valve housing and configured to selectively move the valve between an open position and a closed position, the open position allowing the water to flow through the valve and into the toilet, the closed position preventing the water from flowing through the valve and into the toilet;
at least one sensor disposed within the valve housing and configured to sense an abnormality in at least one of a flow and a pressure of the water and, upon detection of the abnormality, output a signal; and
a control unit housing connectable to the valve, the control unit housing configured to attach along the water supply line;
an annunciator disposed within the control unit housing, the annunciator including at least one of an illuminator and a loudspeaker; and
a controller located in the control unit housing and in communication with the actuator, the at least one sensor and the annunciator, the controller configured to receive the signal from the at least one sensor and, upon receipt of the signal, simultaneously cause the actuator to move the valve into the closed position and cause the annunciator to output an alert to warn a user as to the abnormality, the alert being at least one of a light and a sound.

12. The electronic toilet water control system of claim 11, wherein the alert is a colored light.

13. The electronic toilet water control system of claim 12, wherein the at least one sensor is configured to sense that the abnormality has persisted for a predetermined amount of time.

14. The electronic toilet water control system of claim 13, wherein the at least one sensor is configured to sense at least one of low pressure and high flow of the water for at least five consecutive minutes.

15. The electronic toilet water control system of claim 14, wherein the at least one sensor is configured to sense at least one of the low pressure and no flow of the water for at least three consecutive hours in a 24 hour time period.

16. A method of controlling water supply to a toilet, the toilet being supplied with the water via a water supply line, the method comprising:
providing an electronic toilet water control system including:
a valve having a valve housing, an inlet and an outlet, the valve being configured for connection to the water supply line;
an actuator disposed within the valve housing and configured to selectively move the valve between an open position and a closed position, the open position allowing the water to flow through the valve and into the toilet, the closed position preventing the water from flowing through the valve and into the toilet;
at least one sensor disposed within the valve housing and configured to sense an abnormality in at least one of a flow and a pressure of the water and, upon detection of the abnormality, output a signal; and
a controller in communication with the actuator and the at least one sensor, the controller configured to receive the signal from the at least one sensor and, upon receipt of the signal, cause the actuator to move the valve into the closed position;
sensing, via the at least one sensor, the abnormality in the at least one of the flow and pressure of the water flowing through the valve that has persisted for a predetermined amount of time;
outputting, via the at least one sensor, a signal;
receiving, via the controller, the signal; and
causing, via the controller, the actuator to move the valve into the closed position.

17. The method of claim 16, further comprising the step of:
providing the electronic toilet water control further including an annunciator; and
causing, via the controller, the annunciator to output an alert to warn a user as to the abnormality.

18. The method of claim 17, wherein the annunciator includes at least one of an illuminator and a loudspeaker, and wherein the alert includes at least one of a light and a sound.

19. The method of claim 18, wherein the step of sensing includes sensing, via the at least one sensor, at least one of low pressure and high flow of the water for at least five consecutive minutes.

20. The method of claim 19, wherein the step of sensing includes sensing, via the at least one sensor, at least one of the low pressure and no flow of the water for at least three consecutive hours in a 24 hour time period.
